(19) United States
(12) Patent Application Publication
(10) Pub. No.: US 2002/0084951 A1
(43) Pub. Date: Jul. 4, 2002

(54) Rotating optical display system

(76) Inventor: Bryan L. McCoy, Topanga, CA (US)

Correspondence Address: OPPENHEIMER WOLFF & DONNELLY LLP, 38TH FLOOR, 2029 CENTURY PARK EAST, LOS ANGELES, CA, 90067, US

(21) Appl. No.: 09/752,917

(22) Filed: Jan. 2, 2001

(51) Int. Cl. G09G 3/00

(52) U.S. Cl. 345/31

(57) ABSTRACT

An optical display system includes a point light source or a linear array of point light sources, and a rotating optical subassembly for directing light from said source or sources to at least one viewing station. Resolution may be increased by providing alternate images which are slightly offset from one another, using mirror surfaces at slightly different angles, or using cylindrical lenses with small angle prisms associated with the optical paths. Cross-polarized polarizing layers may also be employed to provide successive images for 3D imaging. Two viewing stations may be provided, along with circuitry for energizing the light source to provide different images at the two viewing stations.

### FIELD OF THE INVENTION

This invention relates to the formation of digital images by rotating optical elements.

### BACKGROUND OF THE INVENTION

It has previously been proposed to generate optical images by rotating mirrors or by rotating a set of cylindrical or columnar lenses, as disclosed in U.S. Pat. No. 4, 457,580, granted Jul. 3, 1984 and U.S. Pat. No. 5,040,058, granted Oct. 13, 1991. The systems of these patents created virtual images using a line of point sources and optical arrangements for moving the image of the light sources while concurrently selectively energizing the light sources.

### SUMMARY OF THE INVENTION

However, the images provided by such prior art systems were somewhat coarse, and lacked the resolution desirable for wide acceptance of the disclosed systems, and these prior art systems were significantly limited in their capabilities.

Accordingly, a principal object of the present invention is to provide optical systems which overcome the shortcomings of the prior art systems. For example, they did not provide for two inputs to provide different images for two different game players.

In accordance with one specific illustrative embodiment of the invention, a two-sided rotating mirror is provided, with a line of light emitting diodes (LED's) or other point light sources adjacent to the periphery of the rotating mirror and extending generally parallel to the axis of rotation of the mirror. As the mirror rotates, a viewer observes light from the LED's, and as the LED's are pulsed, an image is formed which appears to float in space. In order to increase the resolution of the image the images of the LED's are shifted as the images are produced by the two sides of the rotating mirror. The shifting of the LED images may be accomplished by mounting the mirror at a slight angle to the axis of rotation of the mirror, to shift the image by one-half of the spacing between the LED's in the line of LED point light sources. Thus, if the resolution of the array involved 32 pixels or point light source images without this shift, it is increased to 64 pixels, thus doubling the resolution of the image.

Instead of using a tilted mirror, much the same effect may be achieved by mechanically shifting the line of LED's by a distance equal to one-half the spacing between the individual LED's between images observed at the viewing station.

As a third alternative for achieving the increased resolution, the two sides of the rotating mirror may be provided with opaque, non-reflecting lines, or masks, equal in width to the spaces between the lines, and equal in number to the number of LED's, and with the set of lines on one side of the mirror being shifted by one-half of the distance between LED's as compared with the set of lines on the other side of the mirror.

It is further noted that two viewing stations may be provided, and the LED's may be programmed to provide different images at each viewing station.

A three-dimensional or 3D image may be produced by providing a thin sheet of polarizing film oriented longitudinally on one side of the rotating mirror and polarizing film oriented in a transverse direction on the other side of the mirror, and by providing the viewer with polarized viewing glasses with differently polarized lenses. Concurrently, the associated electronic circuitry provides one image when one side of the mirror is providing the virtual image, and another image when the other side of the mirror is producing the image.

Instead of using a rotating mirror, rotating cylindrical lenses or quasi-cylindrical lenses may be employed. With a series of cylindrical lenses being mounted parallel to one another and to the axis of a rotating platform on which they are mounted, a fixed centrally mounted LED linear array may be imaged. By adding prisms having a very low displacement angle to each cylindrical lens, the resolution of the system is increased in a manner somewhat similar to the techniques outlined above for the rotating mirror.

Also, relative to the rotating cylindrical lens construction, a point source may be employed, with an oscillating or reciprocating transversely oriented cylindrical lens at each viewing station.

From a more general standpoint, a rotating optical display system may include a line of point light sources having a predetermined spacing, and a rotating optical subassembly for directing light from said point light sources toward at least one viewing station; and said system including light shifting components for displacing the image seen at said viewing station by an amount somewhat less than the predetermined spacing between the LED's, to significantly increase the resolution of the system. Further, the light shifting components may be part of the rotating optical subassembly, or may constitute arrangements for physically shifting the position of the LED's.

Concerning another broad aspect of the invention, the two sides of the rotating mirror, in the rotating mirror embodiment, may be provided with different optical light control properties. More specifically, this could include image direction shifting, cross-polarization films, or masks, for examples.

In accordance with a further aspect of the invention, systems of the type described above may have two viewing stations with different images supplied to the two viewing stations, and different input image controls for the two images, provided by two different game players, for example.

Other objects featured and advantages of the invention will become apparent from a consideration of the following detailed description, and from the accompanying drawings.

### BRIEF DESCRIPTION OF THE DRAWINGS

FIG. 1 is a perspective view of an optical image display system illustrating the principles of the invention, along with associated electronics for controlling the optical device;

FIG. 2 is a more detailed perspective view of the optical display unit as shown in FIG. 1;

FIG. 3 is a diagrammatic side view of the optical unit of FIGS. 1 and 2 employed to explain some of the principles which are involved;

FIG. 4 is a diagram indicating the nature of the visual image which is produced;

FIG. 5 is a top plan view of the optical unit of FIGS. 1 and 2;

FIG. 6 is a side view of the optical unit of FIGS. 1, 2 and 5;

FIG. 7 is a block circuit diagram indicating the mode of energization of the device of FIGS. 1-6;

FIG. 8 is a perspective view of an alternative embodiment of the invention intended to be worn on the head of the user;

FIG. 9 is a perspective view of an alternative embodiment of the invention utilizing cylindrical lenses;

FIG. 10 is a perspective view of another embodiment of the invention utilizing cylindrical or columnar-type lenses;

FIG. 11 is a cross-sectional view taken through one of the cylindrical-type lenses of the device of FIG. 9;

FIG. 12 is a side view of one of the columnar lenses of FIG. 9; and

FIG. 13 is a diagrammatic showing of a columnar lens system with different images supplied to each of two viewing stations.

### DETAILED DESCRIPTION OF PREFERRED EMBODIMENTS

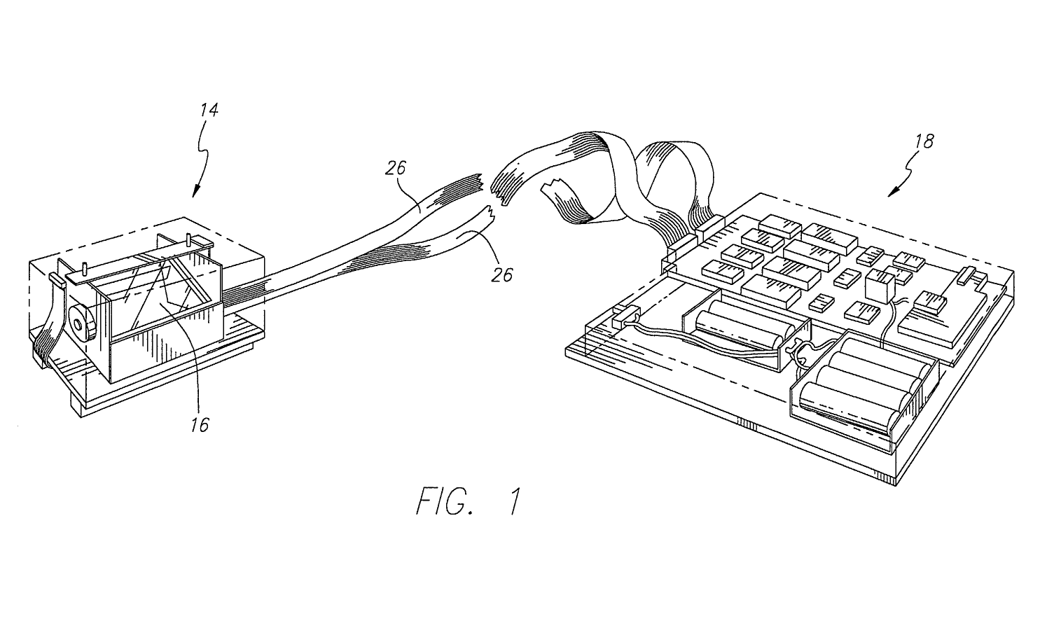

Referring more particularly to the drawings, FIG. 1 shows an optical device 14 including a rotating mirror 16, for producing virtual images, and also shows the physical layout of a circuit board 18 for energizing the optical unit 14.

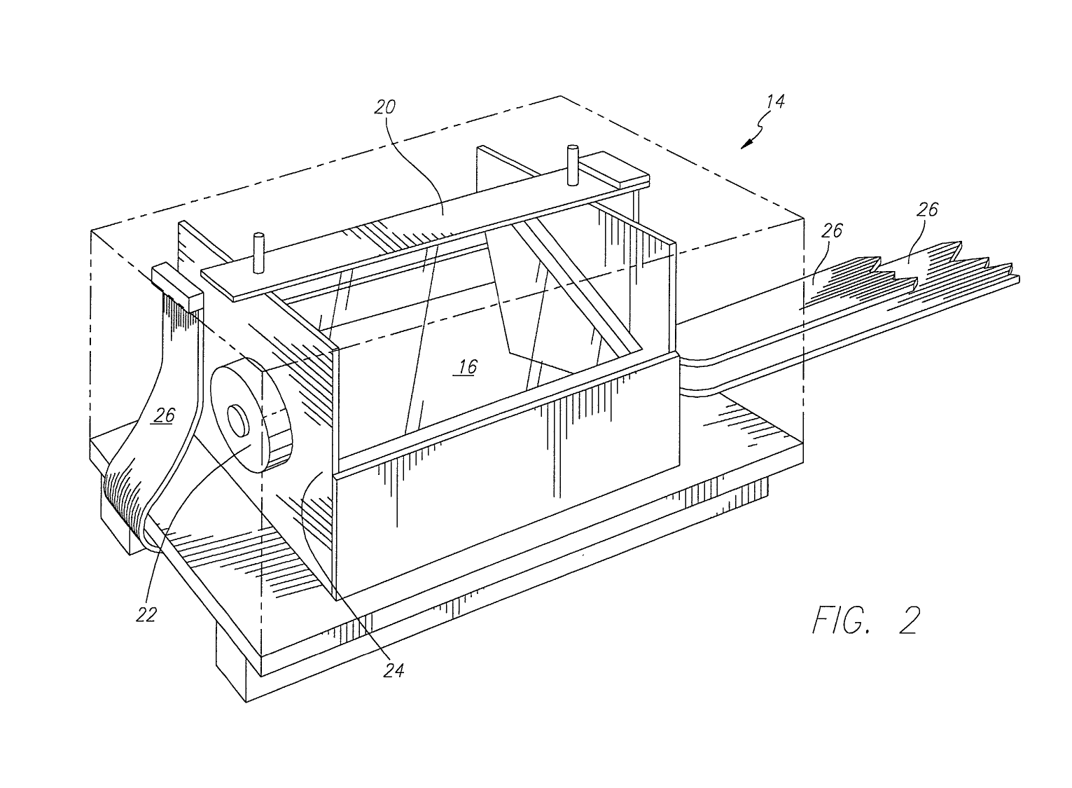

Referring now to FIG. 2, it is a more detailed showing of the optical unit 14 of FIG. 1, including the mirror 16, and the insulating strip 20 which carries, on its underside, a row of light-emitting diodes. A motor 22 which serves to rotate the mirror 16, is mounted on a frame 24. Suitable electrical cabling 26 provides power to rotate the motor and to energize the light-emitting diodes in a manner to be explained in greater detail hereinbelow.

Referring now to FIG. 3, it is a diagrammatic showing of a rotating mirror 16, a series of aligned light-emitting diodes 20, and a frame 24 which supports the rotating mirrors. Virtual images produced by the mirror 16 and the row of diodes 20 may be seen at either viewing station A or viewing station B. The image visible at viewing station A is visible for the time in which the mirror 16 rotates 45° from the point 30 until the same edge of the mirror 16 reaches the point 32. More specifically, as the mirror rotates clockwise, as shown in FIG. 3, the row of light-emitting diodes is initially seen as the location indicated by the block 34 on the mirror 16. As the mirror rotates downward at the right-hand side until the outer edge of the mirror reaches point 32, the image of the light-emitting diodes appears to follow the dash line 36 in the direction indicated by the arrows on this line until the final location indicated by the block 38 when the row of light-emitting diodes is reflected from the left-hand edge of the rotating mirror 16.

At this point 32, when the mirror is substantially horizontal, the image of the light-emitting diodes 20 can first be seen at viewing station B at the right-hand end of the mirror, as indicated by the block 40. During the next 45° of rotation of the mirror 16, the image of the light-emitting diodes as seen at viewing station B moves along the path indicated by the dashed lines and arrows 42 until, when the mirror has shifted 45° the image of the light-emitting diodes appears at station B to be the far end of the rotating mirror in the area indicated by a block 44.

Of course, as the mirror 16 is rotated at relatively high speeds such as 30 times per second or approximately 1800 revolutions per minute, with the line array of diodes being pulsed, a virtual image is seen at both viewing stations A and a different image at viewing station B. With the pulsing of the array of diodes being synchronized with the rotation of the mirror, the resolution of the images which are formed in one direction is determined by the number of pulses of the light-emitting diodes which occurs during the 45° transit of the mirror; and the resolution in the opposite direction is determined by the spacing of the light-emitting diodes, in the absence of additional factors, to be discussed hereinbelow. Now, it is known that the human eye has persistency of vision, so that if an image is presented at a repetition rate of 30 or more times per second, the eye sees a continuous, although possibly changing image. Accordingly, the mirror 16 as shown in FIGS. 2, 5 and 6 is rotated by the motor 22 at a speed in the order of 30 revolutions per second, or about 30×60 or 1800 revolutions per minute.

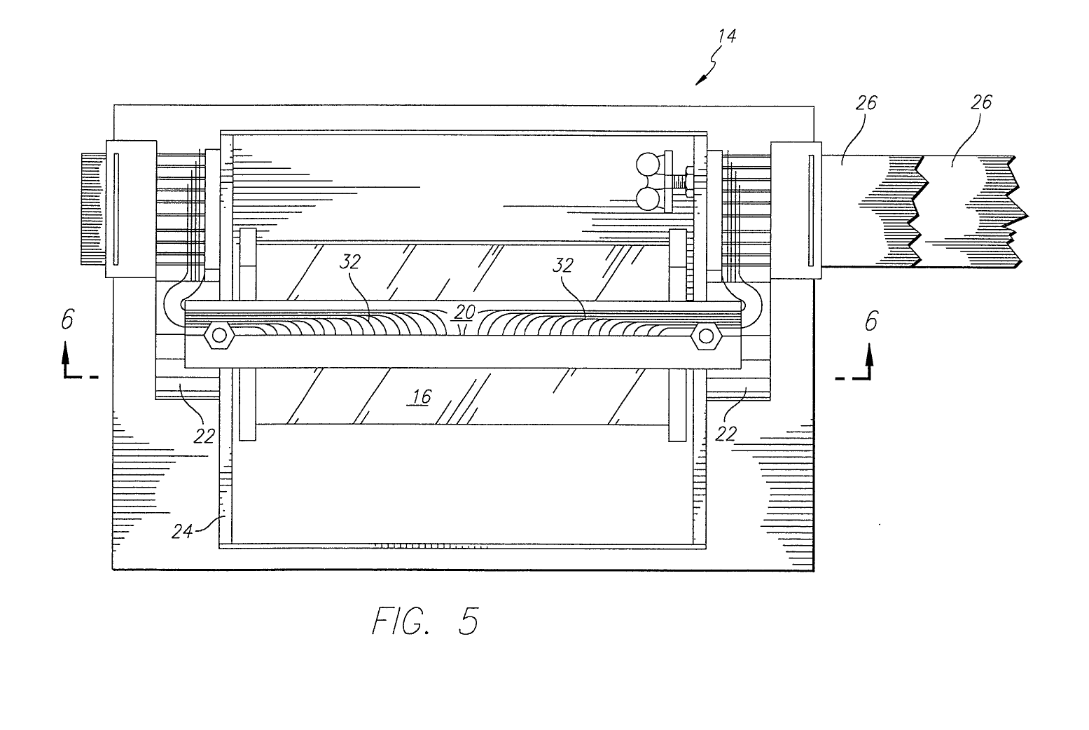

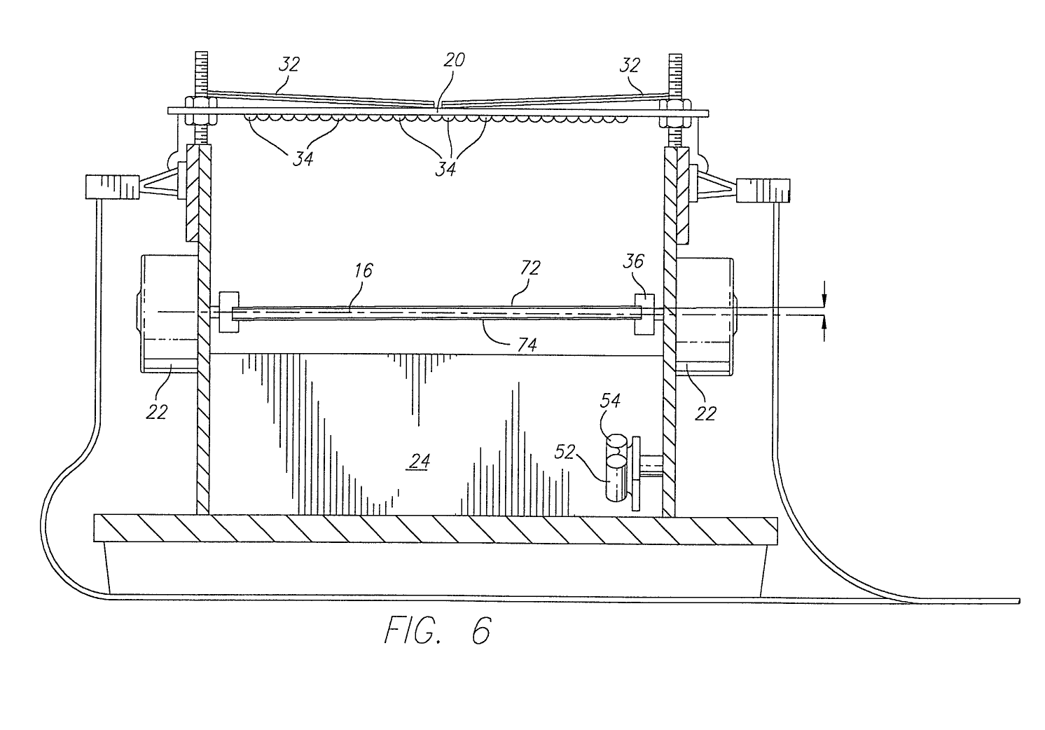

FIG. 5 is a top view of the rotating mirror assembly 14 of FIG. 2, and FIG. 6 is a side view thereof. In FIG. 5 the support 20 for the linear array of LED's is shown, with the input leads 32 for the energization of the LED's also being shown. In the side view of FIG. 6 the row of LED's 34 supported by the insulating strip 20 are clearly shown. Also apparent in FIG. 6 is the mounting 36 of one end of the mirror 16 with this end of the mirror slightly offset from the center of rotation of the mirror assembly. The offset is such as to displace the virtual image of the LED's by a distance equal to one-half the spacing between adjacent LED's. Thus, as the two-sided mirror rotates, the image shifts by a distance of equal to one-half of the spacing between LED's, and the resolution of the virtual image is accordingly doubled.

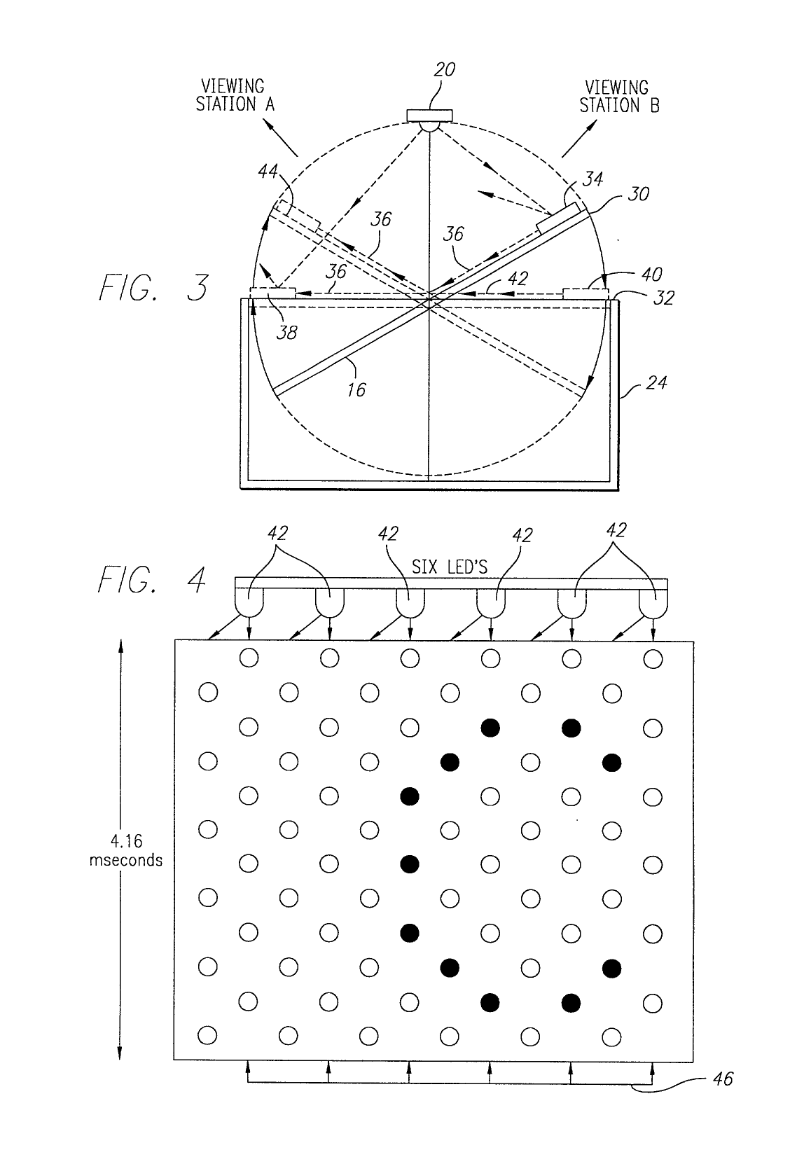

Referring now to FIG. 4 of the drawings, a diagram of a coarse or low-resolution example of the resolution-increasing effect described above will be considered. Initially, for the purposes of FIG. 4, a system involving six LED's 42 mounted on an insulating strip 44, will be considered. In the absence of the off-center mounting of one end of the mirror, the resolution in the transverse direction would only be equal to the number of LED's or six. With the LED array being pulsed 12 times during the 45° or ⅛ of a revolution that the image of the LED array is visible at one viewing station, the resolution would be 6×12 or 72 pixels, as indicated by the columns identified by arrows and bracketed by the line 46 at the bottom of the array. However, with one end of the mirror offset from the axis of rotation, the virtual image of the LED's will be shifted as indicated by the arrows 48, and the resolution in the horizontal direction, as shown in FIG. 4, will be increased from 6 to 12, with the result that the virtual image will be formed of 144 pixels instead of 72 pixels, doubling the image resolution.

In considering the timing of energization of the light-emitting diodes, or LED's, the additional timing LED 52 and photodiode 54 are employed, with the LED 52 directing light toward the mirror as it rotates, and the photodiode 54 and its circuitry being adjusted to provide a pulse only when light is reflected by the mirror from the LED to the photodiode. A small area on one side only of the mirror may be coated with non-reflective material, such as black paint, so that the timing pulse will only be provided once each revolution of the mirror 16.

As mentioned above the persistence of the human eye is such that an image which is repeated 25 or more times per second presents a virtual image which appears to be continuous with little or no flicker. Accordingly the mirror 16 is rotated by the motor 22 at a speed of 30 revolutions per second, or 30×60 or 1800 revolutions per minute.

As discussed above, the virtual image for viewing station A extends over an angle of 45°, and is followed by a 45° angle when a virtual image of the LED's is observed at viewing station B. There is then a 90° interval with no image being presented at either viewing station, followed by a virtual image from the other side of the mirror being observed for 45° at station A, followed by 45° during which a virtual image from the other side of the mirror is seen at viewing station B.

Now, we have noted that the image at viewing station A is presented during 45° of rotation of the mirror. With the mirror rotating at 30 revolutions per second this means that one revolution occurs in 0.0333 seconds, or 33.3 milliseconds. Further, with 45° being equal to ⅛ of the 360° of rotation of the mirror, the virtual image at station A must be formed in 4.16 milliseconds, or about 4,160 microseconds (μsecs).

Referring back to FIG. 4 of the drawings, with an array of 12 by 12 pixels to be presented, the LED's must be pulsed at a pulse repetition rate of about 4,160 divided by 12 or at a rate of about one pulse every 340 microseconds. To provide the 12 lines forming the virtual image, therefore, the row of LED's are pulsed at this pulse repetition rate. Of course, to present a meaningful image, some of the diodes in the linear array are “on” and some are “off” or de-energized during successive pulse intervals. In FIG. 4, by way of example, a number of the pixels have been darkened to indicate that they are “on,” in a pattern to form the letter “C”. In FIG. 4 we used a 12×12 virtual image for convenience in describing the interleaving process. In one embodiment which was constructed an operated, as shown in FIG. 6, 32 LED's were employed in the array. Further, with the mirror being slightly tilted, as discussed above, the virtual image included an array of 64×64 pixels, permitting the display of complex images for game displays or the like. With the rotation of the mirror still being 30 revolutions per second, and the 45° interval for the image formation being equal to about 4.16 milliseconds, or about 4,160 microseconds, the pulse repetition rate for a 64×64 pixel virtual image was about 65 microseconds. In order to produce the desired image, the line of LED's was therefore pulsed at this 65 microsecond interval with a different pulse pattern for each of the 64 time intervals to make up the image for viewing station A.

Then, a similar process with different energizations of the LED's is accomplished to form the virtual image seen at viewing station B. Following 90° of rotation of the mirror (when the LED's need not be energized) the offset images provided by the other side of the mirror are produced. The result, as discussed above, using a 32 LED row of LED's, is to provide a virtual image of double resolution, or a 64-bit by 64-bit array.

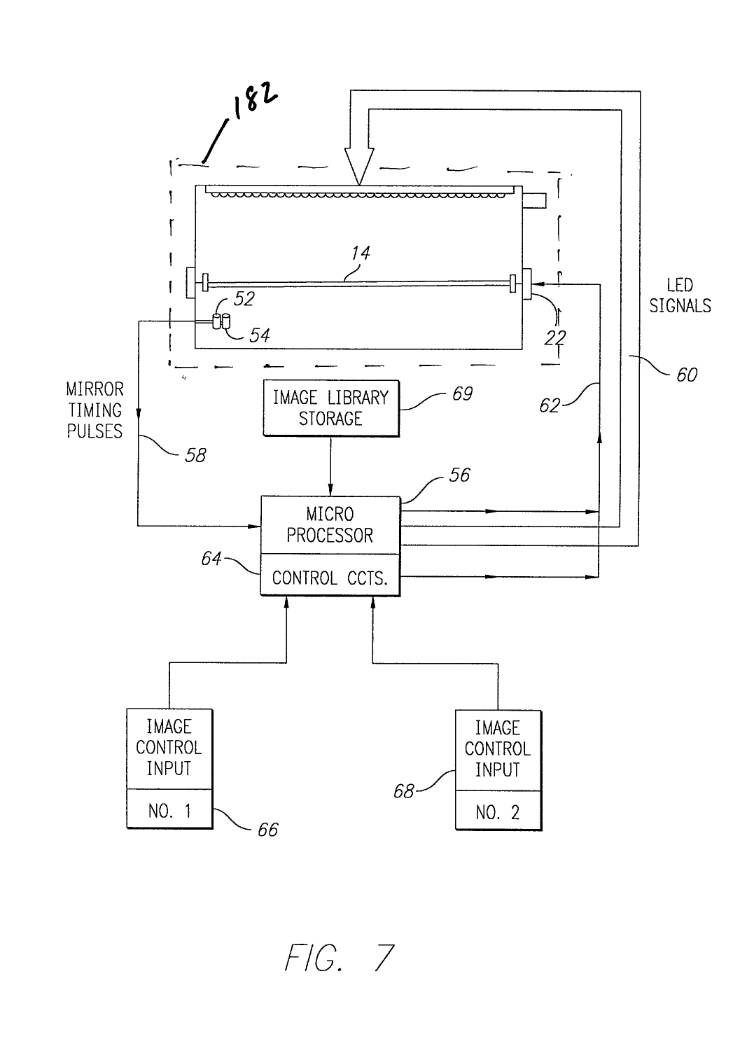

Referring now to FIG. 7 of the drawings, a rotating mirror assembly 14 as shown in FIGS. 1, 2, 5 and 6 is shown along with the associated electronic circuitry. More specifically, the microprocessor 56 is shown receiving signals on lead 58 from the timing signal generator 52, 54, and directing signals to the LED's via the cable 60. Power is supplied to the motor 22 over circuit 62 from the control circuits 64.

Image control signals are supplied from input circuitry 66 and 68 to the control circuit 64, and are processed in the microprocessor 56 to supply the changing images to the LED linear array over the bus 60. More specifically, circuit 66 may provide images for viewer station A of FIG. 3, while circuit 68 may provide images for viewer station B, with the LEDs being illuminated for each viewer during the intervals discussed hereinabove relative to FIGS. 3 and 4. In addition, appropriate game play or standard images may be accessed from the image library storage unit 69. In game play, one player may operate input 66 and view at viewing station A, while the other operator may operate input 68 and view a different image at viewing station B. For game play, the input controls 66 and 68 may be the joystick and fire control switching signals normally employed in action games.

Referring again to FIG. 6 of the drawings, the mirror 16 is provided with polarized films 72 and 64 on the two sides thereof, with one of the polarized films being polarized longitudinally or parallel with respect to the axis of rotation of the mirror, and the other being polarized transverse to the axis of rotation. Then, as the mirror is rotating, alternate 3D or stereoscopic images are provided toward the viewer at station A, and also a different set of 3D images are directed toward the viewer at station B. Using cross-polarized glasses, the viewers at each of station A and B observe three-dimensional or stereoscopic images. Of course, the images provided over the bus 60 to the linear LED array are appropriate stereoscopic images, with the images alternating as the mirror rotates.

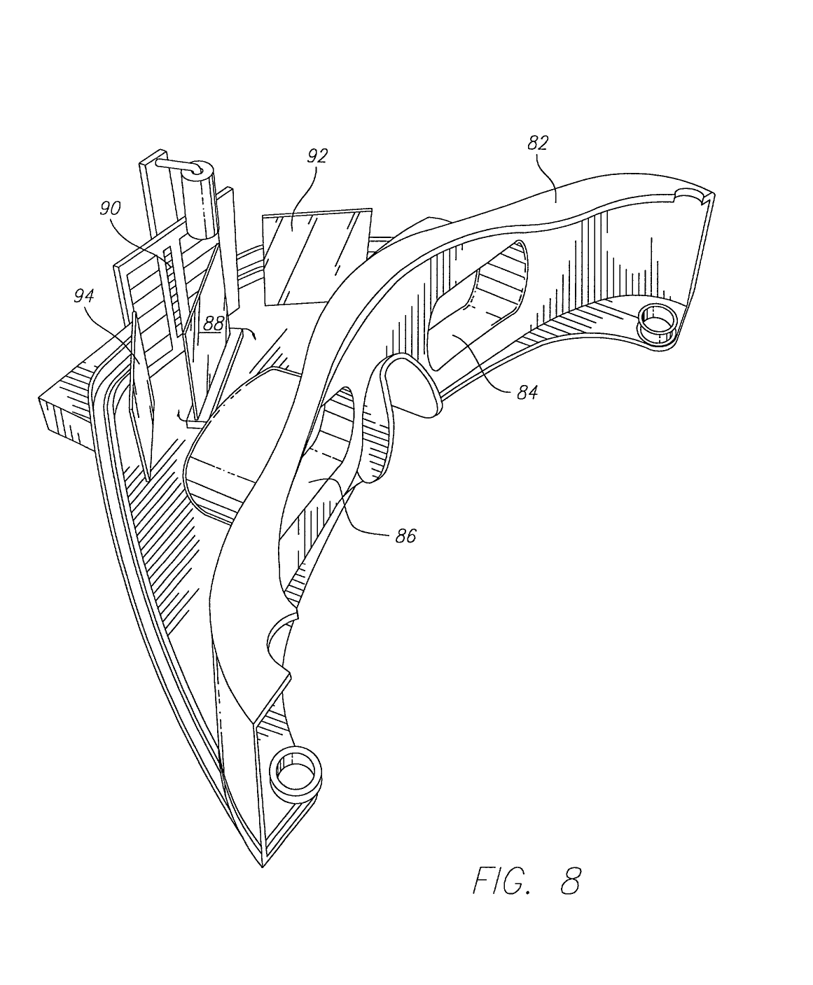

Referring now to FIG. 8 of the drawings, it shows a binocular version of the rotating mirror embodiment of FIGS. 1 through 6 of the drawing. More specifically, FIG. 8 shows a frame 82 with two viewing openings 84 and 86. Centrally mounted on the frame 82 is the rotating mirror 88, which directs light from the series of light-emitting diodes 90 toward the mirror 92 which might correspond to viewing station B in FIG. 3, and also to mirror 94 which corresponds to viewing station B in FIG. 1. From the mirrors 92 and 94 the images are transmitted back individually and respectively to the optical openings 84 and 86. In this embodiment of the invention, stereoscopic images are applied proper timing of the energization of the light-emitting diodes 90 with the rotation of the mirror 88. Thus, during successive 45° intervals images representing one view of a scene are transmitted via the reflecting mirror 92, and during the next 45° segment of the mirror rotation, images are directed to the viewer via mirror 94. Using stereoscopic images, a full three-dimensional view is received by the user through the optical viewing windows 84 and 86.

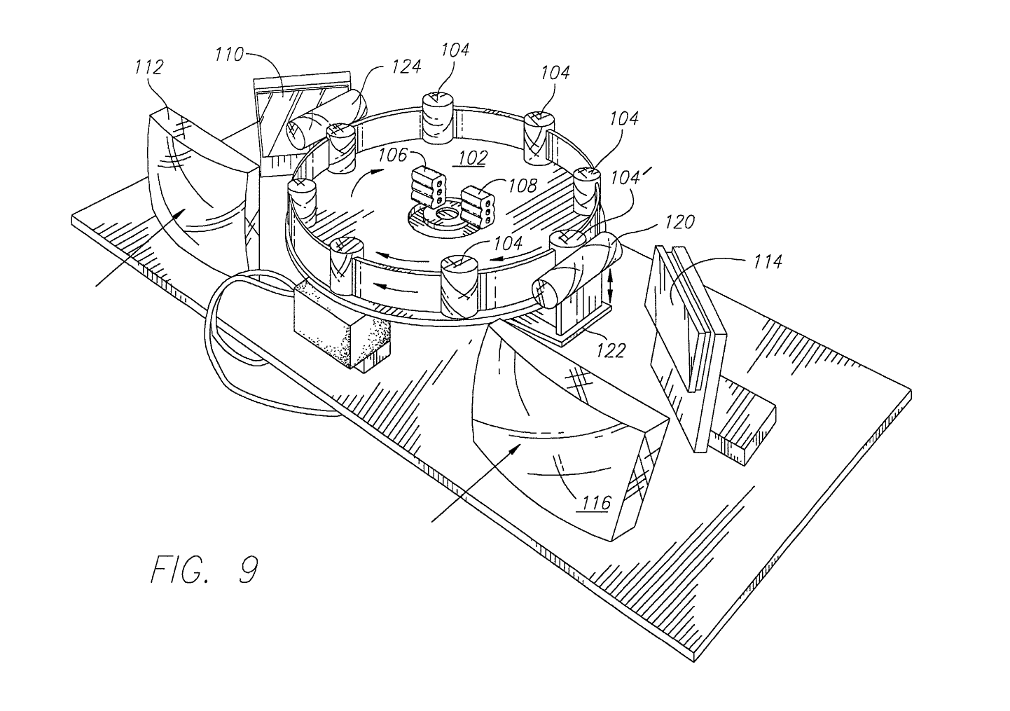

FIG. 9 shows another embodiment of the invention, in which cylindrical lenses are employed instead of the rotating mirrors employed in the earlier embodiments of the invention. More specifically, the rotating subassembly 102 includes eight cylindrical lenses 104 mounted around its periphery, with fixed LED assemblies 106 and 108 mounted within the ambit of the rotating cylindrical lenses 104. The LED's 108 constitute a set of three LED's which may be red, blue and green, with the set 106 directing light toward the mirror 110 and the viewing lens 112, while the set of LED's 108 is directing light toward the mirror 114 which in turn reflects the virtual image toward the viewing lens 116. Assuming that a monocolor image is being transmitted, for purposes of illustration, the cylindrical lenses such as the particular lens 104 prime will provide an image radially outward from the center of the rotating assembly 102 toward the reciprocating lens 120. A single one of the LED's included in the triplet set 108 is pulsed at high speed, and synchronism with the rotation of the lens 104 prime, and the up-and-down reciprocating action of the cylindrical lens 120. As the lens 104′ moves through a relatively small angular distance such as defined by the length of the cylindrical lens 120, the image provided by the LED is traversed horizontally. In the meantime, the lens 120 is mounted on a vibrating support 122 which moves very rapidly up and down, to provide the second degree of virtual imaging of the single LED. Accordingly, with the rotating subassembly 102 moving at high speeds in the circular direction, and the cylindrical lens moving up and down at a much higher rate of speed, a full two dimensional digital image is provided to the left eye of the viewer through the lens 116 and the mirror 114. Similarly, with the high-speed vertical reciprocation of the cylindrical lens 124, a different image is provided to the right eye of the viewer via mirror 110 and the viewing lens 112. By energizing the light-emitting diodes 106 and 108 in the proper image-forming sequence and in synchronism with the rotation of the lenses 104 and the vertical reciprocation of the lenses 120 and 124, a 3D image may be seen by the viewer.

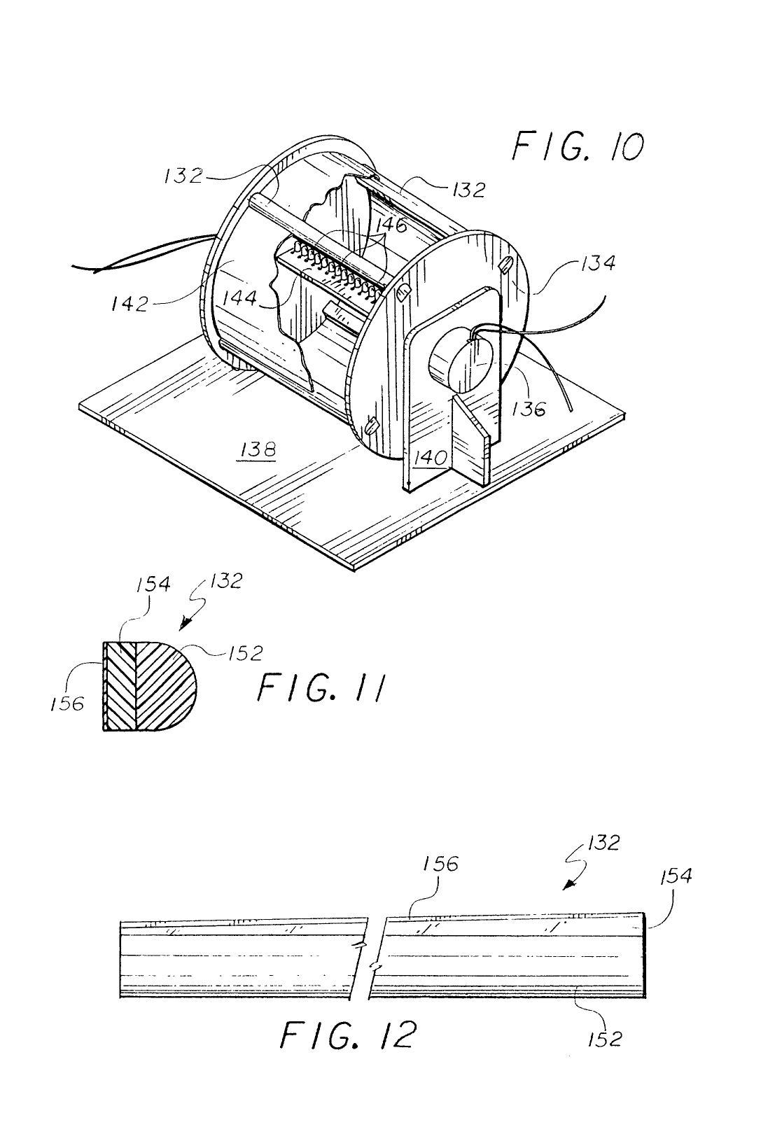

Referring now to FIG. 10 of the drawings, another alternative embodiment of the cylindrical lens or columnar lens image-forming devices, is shown. More specifically, relative to FIG. 10, it includes four cylindrical or columnar lenses 132 mounted on a frame 134 which is rotated at relatively high speeds by the motor 136, with a suitable base 138 and bearing support structure 140, being provided.

Between the lenses 132 is opaque cylindrical shielding material 142 which is a cutaway in FIG. 10 for easy viewing of the inner construction. Within the rotating assembly is a fixed insulating strip 144 having a series of light-emitting diodes 146 mounted thereon. As the frame 134 rotates, the light-emitting diodes 146 are pulsed, and a virtual image may be seen by the viewers.

In accordance with the present invention, arrangements are provided to increase the resolution provided by the linear array of light-emitting diodes 146; and this will be further elaborated in course of the description of 11 and 12 of the drawings. FIG. 11 is a cross-sectional view through one of the cylindrical or columnar lenses 132. More specifically, each of the columnar lenses 132 includes the basic lens portion 152, a very gradual prism 154 and they may also optionally include a polarizing film 156.

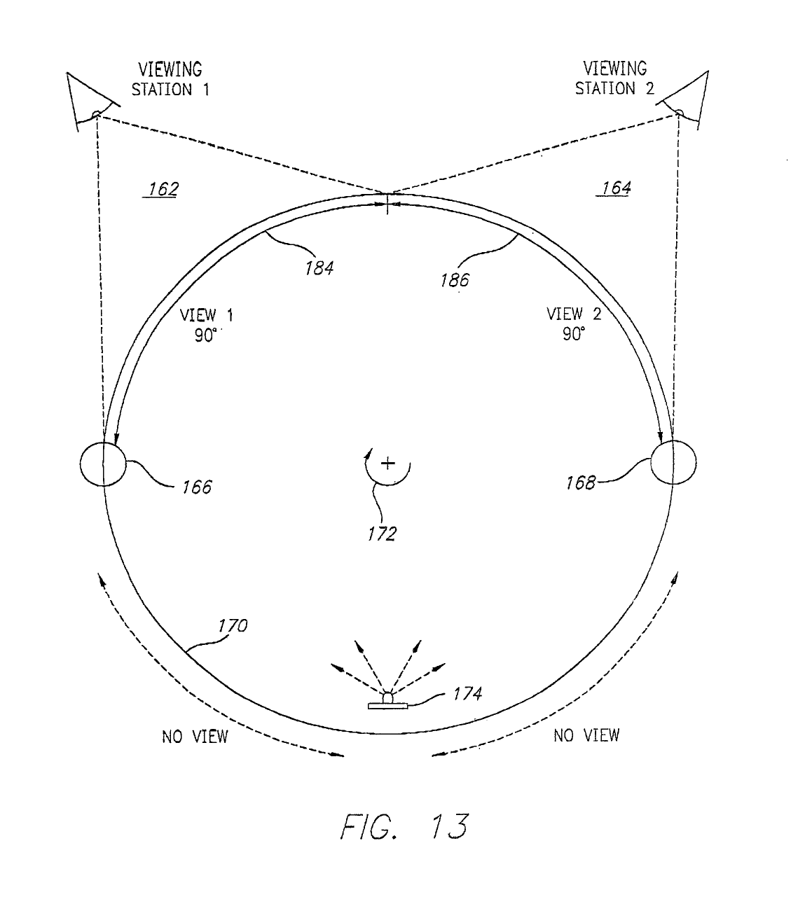

It may be recalled in connection with the embodiment of the invention shown in the first few figures of the drawings, that the resolution of the virtual image was increased by shifting successive images by a distance equal to one-half of the spacing between the light-emitting diodes. In the embodiment of FIGS. 10-12, a similar effect is provided through the use of the very gradual prisms 154. More specifically, with four columnar or cylindrical lenses 132, each of the prisms 154 will have a slightly different angle, with one of the lenses having no prism angle and the other three prisms having front angles sufficient to shift the image of the LED's by one-quarter, one-half, or three-quarters, respectively of the distance between the LED's. With this configuration, the effective resolution provided by the system of FIGS. 10-12 is increased by a factor of four. Thus, as the optical assembly 134 rotates, the images of the row of light-emitting diodes 146 is shifted by one-quarter of the distance between the successive LED's. Thus, if in a particular example, there were 20 LED's, the virtual image would have a resolution equal to 80 pixels in the transverse direction. Accordingly, the associated electronics would pulse the LED's to produce an image, 80 times during the zone (approximately 90°) where the virtual image is to be observed. The resulting virtual image would have a resolution of 80 pixels in the transverse direction and also 80 pixels in the rotary direction.

FIG. 13 is a diagrammatic showing of a volumnar lens system with two viewing stations 162 and 164. In FIG. 13, the two lenses 166 and 168 are mounted on a frame 180 for rotation as indicated by arrow 172. A fixed linear array of light emitting diodes 174 extends perpendicularly relative to the plane of the drawing of FIG. 13. As the lens assembly rotates, the LED array 174 is pulsed, providing different images to the two viewing stations 162 and 164.

Referring back to FIG. 7 of the drawings, reference is made to the dashed line box 182. The assembly shown schematically in FIG. 13 may be substituted for the mirror assembly within box 182. Of course, in this substitution, the angular position of the frame 170 of FIG. 13 would be indicated by any appropriate mechanism, such as a light emitting diode, a photo transistor, and a localized extension of the frame 170 from which a synchronizing pulse would be derived.

In operation, during the time interval while one of the lenses is traversing the 90° path indicated by the arrow 184, the LED array 174 is pulsed to provide a first image to viewing station 162; while during the transit of the lens through the arc indicated by arrow 186, a second different image is supplied by the LED array 174. Accordingly, the diagram of FIG. 13 represents another alternative for providing two viewing stations supplied with different images, independently controlled.

It is to be understood that the foregoing detailed description and the accompanying drawings relate to specific embodiments of the invention. Various alternatives and modifications may be accomplished to achieve the same result, without departing from the spirit and scope of the invention. Thus, by way of example and not of limitation, the point light sources could be implemented by arrangements other than light-emitting diodes. Further, concerning the electronic system as described generally in FIG. 7 of the drawings, this may be implemented by many known specific display control circuits known in the art, with the circuit of FIG. 7 merely being a broad block diagram indicating the nature of the controls which would be employed. Further, regarding the specific constructions, other known optical techniques may be employed to implement various optical elements which are shown in the drawings. Accordingly, present invention is not limited to the precise embodiments shown in the drawings and described in detail hereinabove.

what is claimed is:

1. A rotating optical display system comprising:
a line array of point light sources having a predetermined spacing between successive light sources;
a rotating mirror subassembly for directing light from said point light sources toward at least one viewing station, said mirror subassembly including a mirror which is flat with reflecting surfaces on both sides, said mirror subassembly having a predetermined axis of rotation;
said mirror subassembly being oriented to direct light from said light sources at a predetermined angle toward said viewing station from one side of said mirror;
said mirror having one end mounted off center from the axis of rotation of said mirror subassembly to direct light sources to said viewing station in a direction slightly shifted from said predetermined angle by an increment less than the spacing between said point light source; whereby the images received at said viewing station at successive intervals of time are interleaved to provide an image with increased resolution in the direction of said line of point sources;
said system including first and second viewing stations; and
circuitry for energizing said line of point sources to provide a first image to said first viewing station, and a second different image to said second viewing station.

2. A display system as defined in claim 1 wherein light-polarizing layers oriented in opposite directions are mounted on the two sides of said mirror.

3. A rotating optical display system comprising:
a line array of point light sources having a predetermined spacing between successive light sources;
a rotating mirror subassembly for directing light from said point light sources toward at least one viewing station, said mirror subassembly including a mirror which is flat with reflecting surfaces on both sides, said mirror subassembly having a predetermined axis of rotation;
said mirror subassembly being oriented to direct light from said light sources at a predetermined angle toward said viewing station from one side of said mirror; and
said mirror having one end mounted off center from the axis of rotation of said mirror subassembly to direct light sources to said viewing station in a direction slightly shifted from said predetermined angle by an increment less than the spacing between said point light source;
whereby the images received at said viewing station at successive intervals of time are interleaved to provide an image with increased resolution in the direction of said line of point sources.

4. A display system as defined in claim 3 wherein light-polarizing layers oriented in opposite directions are mounted on the two sides of said mirror.

5. A display system as defined in claim 3 wherein two viewing stations are provided to view different images transmitted in different directions from said rotating assembly, and circuitry is provided to energize said point light sources to form said different images.

6. A display system as defined in claim 3 wherein said rotating mirror has different line masks on the two sides thereof.

7. A rotating optical display system comprising:
a line of point light sources having a predetermined spacing between successive light sources;
a rotating optical subassembly for directing light from said point light sources toward at least one viewing station;
a first optical light directing portion of said subassembly for directing light from said light sources at a predetermined angle toward said viewing station; and
a second light directing portion of said subassembly for directing light from said light sources to said viewing station in a direction slightly shifted from said predetermined angle by an increment less than the spacing between said point light sources;
whereby the images received at said viewing station at successive intervals of time are interleaved to provide an image with increased resolution in the direction of said line of point sources.

8. A display system as defined in claim 7 wherein said second light-directing portion shifts the light by an amount substantially equal to a fraction of the predetermined spacing between light sources.

9. A display system as defined in claim 7 wherein said portions of said rotating assembly are mirror surfaces.

10. A display system as defined in claim 7 wherein said portions of said rotating subassembly are columnar lenses with an offset prism associated with at least one of said columnar lenses.

11. A rotating optical display system comprising:
a line of point light sources having a predetermined spacing between successive light sources;
a rotating optical subassembly for directing light form said point light sources toward at least one viewing station;
a first optical light directing portion of said subassembly for directing light from said light sources with a predetermined orientation toward said viewing station; and
a second light directing portion of said subassembly for directing light from said light sources to said viewing station with an orientation shifted from said predetermined orientation;
whereby the images received at said viewing station at successive intervals of time are interleaved to provide enhanced images.

12. A display system as defined in claim 11 wherein said portions of said rotating subassembly are mirror surfaces.

13. A display system as defined in claim 11 wherein said portions of said rotating subassembly are cylindrical lenses with an offset prism associated with at least one of said cylindrical lenses.

14. A display system as defined in claim 11 wherein said first light directing portion provides an image in polarized light polarized in one orientation, and the second light directing portion provides an image polarized in a direction substantially cross-polarized relative to said one orientation.

15. A display system as defined in claim 11 wherein said second light directing portion shifts the image of said line of point sources by an amount substantially equal to a fraction of the predetermined spacing of said light sources.

16. A rotating optical display system comprising:
at least one point light source;
a rotating optical subassembly for directing light from said point light source toward at least one viewing station;
a first optical light directing portion of said subassembly for directing light from said light sources with a predetermined orientation toward said viewing station; and
a second light directing portion of said subassembly for directing light from said light source to said viewing station with an orientation shifted from said predetermined orientation to provide an improved image;
whereby the images received at said viewing station at successive intervals of time are interleaved to proved enhanced images.

17. An optical system as defined in claim 16 wherein said portions of said rotating subassembly are mirror surfaces.

18. An optical system as defined in claim 16 wherein said portions of said rotating subassembly are cylindrical lenses with an offset prism associated with at least one of said cylindrical lenses.

19. An optical system as defined in claim 16 wherein said portions of said rotating subassembly are a set of cylindrical or columnar lenses oriented in a predetermined direction; and
said system further comprising an additional cylindrical or columnar lens oriented substantially perpendicular to said set of lenses, and mounted in the path of said images for reciprocation, to provide a complete two-dimensional virtual image.

20. A display system as defined in claim 16 wherein said first light directing portion provides an image in polarized light polarized in one orientation, and the second light directing portion provides an image polarized in a direction substantially cross-polarized relative to said one orientation.

21. A display system as defined in claim 16 wherein said system includes a plurality of different colored light sources.

22. A display system as defined in claim 16 wherein said system includes a linear array of point light sources.

23. A rotating optical display system comprising:
at least one point light source;
a rotating optical subassembly for directing light from said light source toward first and second angularly displaced viewing stations; and
circuitry for energizing said light source to provide a first image to said first viewing station, and a second different image to said second viewing station.

24. A system as defined in claim 23 wherein said rotating optical subassembly is a flat mirror with two reflecting surfaces.

25. A system as defined in claim 23 wherein said light source is a linear array of point light sources.

26. A system as defined in claim 23 wherein said rotating optical subassembly includes a plurality of columnar lenses.
